(19) United States
(12) Patent Application Publication
(10) Pub. No.: US 2026/0171439 A1
(43) Pub. Date: Jun. 18, 2026

(54) HUMIDIFIER

(71) Applicants: Hyundai Motor Company, Seoul (KR); Kia Corporation, Seoul (KR)

(72) Inventors: Ju Yong LEE, Hwaseong-Si (KR); Jin Hun LEE, Hwaseong-Si (KR); Seong Yun HWANG, Hwaseong-Si (KR); Hyun Yoo KIM, Hwaseong-Si (KR); Ho Kyo JUNG, Hwaseong-Si (KR)

(21) Appl. No.: 19/203,688

(22) Filed: May 9, 2025

(30) Foreign Application Priority Data
Dec. 18, 2024 (KR) 10-2024-0190377

(51) Int. Cl. H01M 8/04119

(52) U.S. Cl. CPC H01M 8/04149

(57) ABSTRACT

A humidifier includes a mid-casing member having therein a space and having a first hole formed at one side thereof, and a second hole formed at the other side thereof, a cartridge part including a plurality of cartridge members accommodated in the mid-casing member and disposed to be spaced apart from one another in a first direction D1, and humidification membrane members accommodated in the cartridge members, in which two opposite ends of the plurality of cartridge members based on the first direction D1 are positioned within a width of the first hole in the first direction D1.

### CROSS-REFERENCE TO RELATED APPLICATION

This application claims priority to and the benefit of Korean Patent Application No. 10-2024-0190377 filed in the Korean Intellectual Property Office on Dec. 18, 2024, the entire contents of which are incorporated herein by reference.

### TECHNICAL FIELD

The present disclosure relates to a humidifier, and more particularly, to a humidifier capable of being applied to a fuel cell system.

### BACKGROUND

A humidifier applied to a fuel cell system may be configured to appropriately adjust a humidity of air or the like to be supplied to a fuel cell. The humidifier may improve/optimize performance and lifespan of a fuel cell. In general, the humidifier may operate to adjust a humidity of air or the like to be supplied to the fuel cell by using drain water discharged from the fuel cell stack.

In a state in which water stagnates at/in a bottom of the humidifier, a large amount of air may sometimes be introduced suddenly into the humidifier in accordance with an output required for the fuel cell system. In this case, the water stagnating at/in the bottom of the humidifier, may be scattered by a flow of air. The scattered water may sometimes come into contact with a humidification membrane. Water contacting the humidification membrane may promote a chemical degradation of the humidification membrane. For example, a sweeping process in which a partial region of the humidification membrane in the humidifier is cleaned by a fluid (such as air) cannot be properly performed, which may cause a problem in that the degradation of the humidification membrane occurs more frequently and/or at an accelerated rate.

The matters described in this Background section are only for enhancement of understanding of the background of the disclosure, and should not be taken as acknowledgement that they correspond to prior art already known to those skilled in the art.

### SUMMARY

The following summary presents a simplified summary of certain features. The summary is not an extensive overview and is not intended to identify key or critical elements.

Systems, apparatuses, and methods are described for a humidifier. A humidifier may comprise: a casing having a surface in which a first hole and a second hole are formed; a cartridge part comprising a plurality of cartridges accommodated in a space formed by the casing, wherein the plurality of cartridges are disposed to be spaced apart from each other in a first direction; and a plurality of humidification membranes accommodated in the plurality of cartridges. The plurality of cartridges may be positioned within a width of the first hole in the first direction, such that channels are formed between outer cartridge members, of the plurality of cartridges in the first direction, and an internal surface of the casing.

Also, or alternatively, a humidifier may comprise: a casing having a surface in which a first hole and a second hole are formed; a plurality of cartridges accommodated in a space formed by the casing, wherein the plurality of cartridges are disposed to be spaced apart from each other in a first direction; and a plurality of humidification membranes accommodated in the plurality of cartridges. Each cartridge of the plurality of cartridges may comprise a window region in which through-holes are formed, wherein each window region comprises: a first window region, provided towards a first end of the cartridge in a second direction intersecting the first direction, in which one or more first through-holes are formed; and a second window region, provided towards a second end of the cartridge opposite the first end in the second direction, in which one or more second through-holes are formed, wherein at least one of the first window region or the second window region comprise portions with different thicknesses.

Also, or alternatively, a humidifier may comprise: a casing having a surface in which a first hole and a second hole are formed; a plurality of cartridges in a space formed by the casing, wherein the plurality of cartridges are disposed to be spaced apart from each other in a first direction and spaced apart from internal surfaces of the casing facing the first direction, such that a plurality of channels are formed, from the first hole, between the plurality of cartridges and the internal surfaces of the casing; and a plurality of humidification membranes accommodated in the plurality of cartridges.

These and other features and advantages are described in greater detail below.

### BRIEF DESCRIPTION OF THE DRAWINGS

FIG. 1 is a view illustrating a first cross-sectional structure of a humidifier according to the present disclosure.

FIG. 2 is a view illustrating a second cross-sectional structure of the humidifier according to the present disclosure and illustrating a cross-sectional structure around a first hole.

FIG. 3 is an enlarged view illustrating a window region of a cartridge member provided in the humidifier according to the present disclosure.

FIG. 4 is an enlarged view illustrating a cross-sectional structure of a bypass space formed in the humidifier according to the present disclosure and cross-sectional structures of components around the bypass space.

FIG. 5 is a view for explaining a discharge hole of the cartridge member provided in the humidifier according to the present disclosure.

FIG. 6 is an enlarged view illustrating a cross-sectional structure of a drain pipe part provided in the humidifier according to the present disclosure and cross-sectional structures of components around the drain pipe part.

### DETAILED DESCRIPTION

Unless otherwise defined, the terms used herein, including technical or scientific terms, may have meanings generally understood by those skilled in the art to which the present disclosure belongs.

The expressions such as “comprise”, “may comprise”, “include”, “may include”, “have”, “may have”, etc. as used herein are intended to mean the presence of a characteristic (e.g., function, operation, component, etc.) and do not exclude the presence of other additional characteristics. That is, these expressions should be understood as open-ended terms that encompass the possibility that other examples are included.

A singular expression used herein may include the meaning of the plural unless otherwise stated in the context, which also applies to the singular expression described in the claims.

The expression “based on” as used herein is intended to describe one or more factors that influence an act or operation of determining or deciding described in a phrase or sentence including that expression, and this expression does not exclude any additional factors that influence the act or operation of determining or deciding.

When it is described that a component (e.g., a first component) is “connected” or “coupled” to another component (e.g., a second component) as used herein, it may mean that the component is not only directly connected or coupled to another component, but also connected or coupled through yet another component (e.g., a third component).

Depending on the context, the expression “configured to” as used herein may have meanings such as “set to”, “with the ability to”, “modified to”, “made to”, “to be able to”, etc. This expression is not limited to the meaning of “specially designed in hardware to”. For example, a processor configured to perform a specific operation may refer to a generic purpose processor capable of performing the specific operation by executing software, or to a special purpose computer structured through programming to perform the specific operation.

Expressions such as “first” or “second” as used herein are used to distinguish one object from another in referring to multiple similar objects, unless otherwise indicated in context, and do not limit the order or importance between them. For example, a plurality of chips according to the present disclosure may be distinguished from each other by referring them as “first chip”, “second chip”, respectively. For purposes of this application and the claims, using the exemplary phrase “at least one of: A; B; or C” or “at least one of A, B, or C,” the phrase means “at least one A, or at least one B, or at least one C, or any combination of at least one A, at least one B, and at least one C. Further, exemplary phrases, such as “A, B, or C”, “at least one of A, B, and C”, “at least one of A, B, or C”, etc. as used herein may mean each listed item or all possible combinations of the listed items. For example, “at least one of A or B” may refer to (1) at least one A; (2) at least one B; or (3) at least one A and at least one B. “One or more of” is synonymous with “at least one of” herein.

Hereinafter, a humidifier according to the present disclosure will be described with reference to the drawings.

### Humidifier

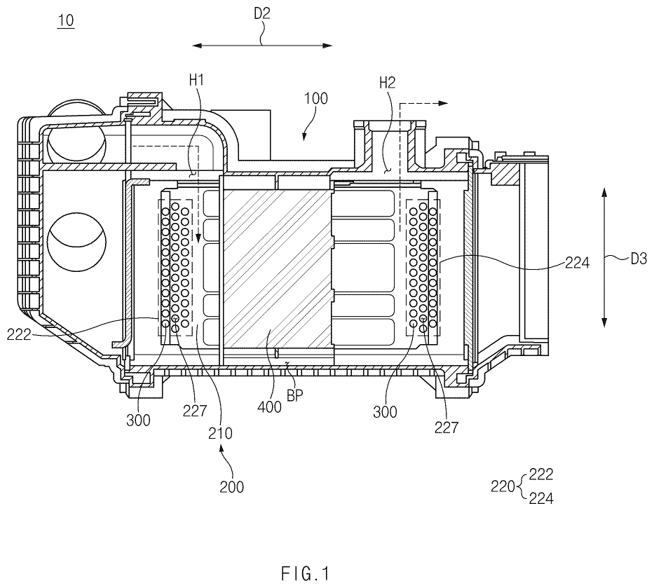

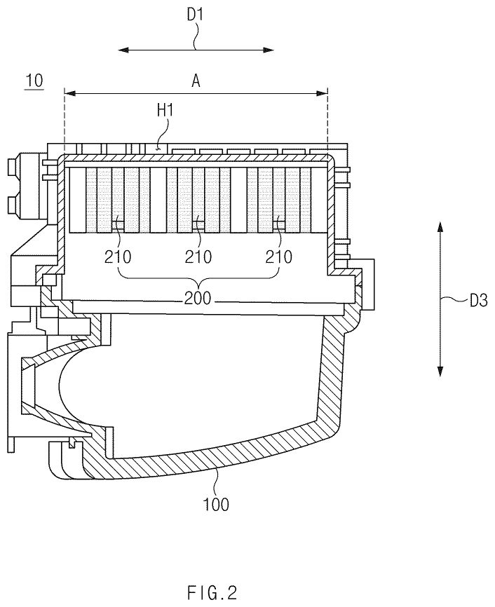

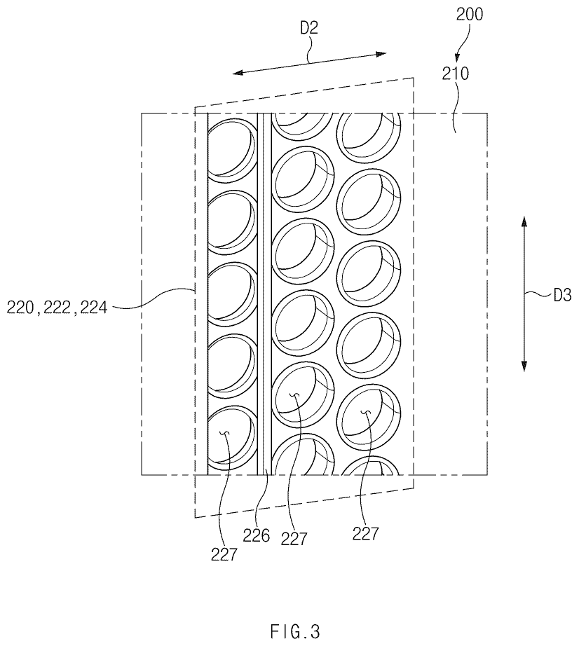

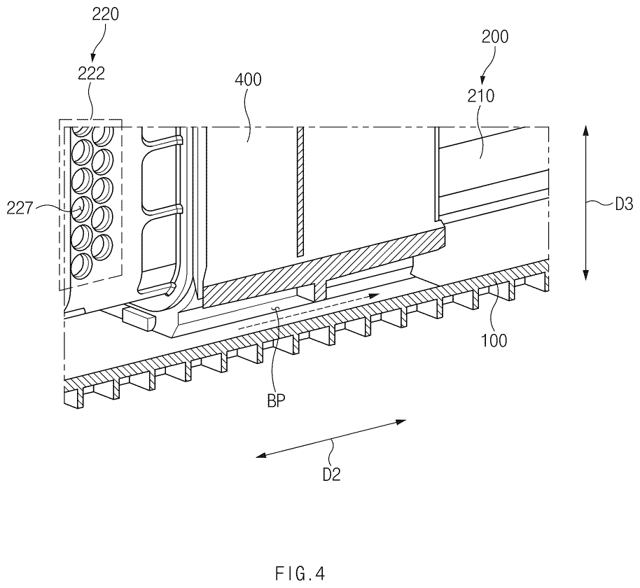

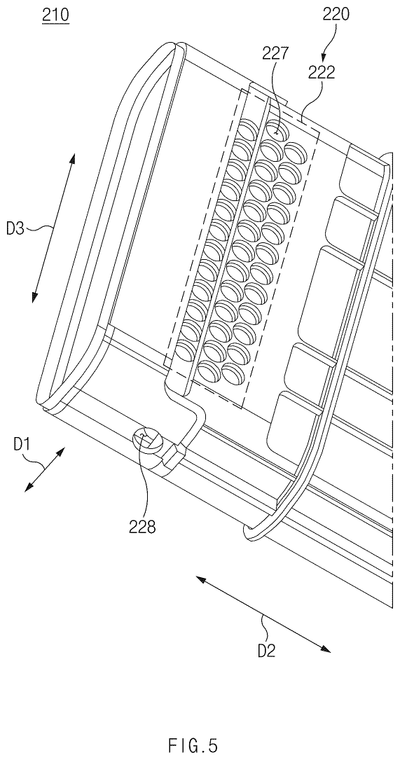

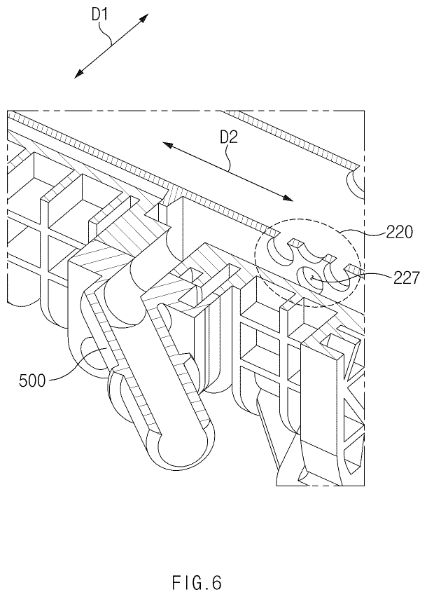

FIG. 1 is a view illustrating a first cross-sectional structure of a humidifier according to the present disclosure, and FIG. 2 is a view illustrating a second cross-sectional structure of the humidifier according to the present disclosure and illustrating a cross-sectional structure around a first hole. FIG. 3 is an enlarged view illustrating a window region of a cartridge member provided in the humidifier according to the present disclosure, and FIG. 4 is an enlarged view illustrating a cross-sectional structure of a bypass space formed in the humidifier according to the present disclosure and cross-sectional structures of components around the bypass space. FIG. 5 is a view for explaining a discharge hole of the cartridge member provided in the humidifier according to the present disclosure, and FIG. 6 is an enlarged view illustrating a cross-sectional structure of a drain pipe part provided in the humidifier according to the present disclosure and cross-sectional structures of components around the drain pipe part.

The humidifier according to the present disclosure may be a humidifier capable of being applied to a fuel cell system. For example, the humidifier according to the present disclosure may be a device for improving/maximizing driving efficiency of a fuel cell by humidifying/controlling humidity of air required to operate the fuel cell.

With reference to FIGS. 1 to 3, a humidifier 10 according to the present disclosure may include a mid-casing member 100 (e.g., a casing) having/forming therein a space. A first hole H1 may be formed at a first side of the mid-casing member 100, and a second hole H2 may be formed at a second side of the mid-casing member 100. A cartridge part 200 (e.g., a cartridge holder/portion) may include/accommodate a plurality of cartridge members 210 (e.g., a plurality of cartridges). The cartridge part 200 may be accommodated/comprised in the mid-casing member 100. For example, the cartridge members 210 may be disposed to be spaced apart from one another in a first direction D1 (e.g., perpendicular to directions D2 and D3 in FIG. 1, shown in FIGS. 2, 5, 6). The humidifier 10 according to the present disclosure may include one or more humidification membrane members 300 (e.g., one or more humidification membranes) accommodated in the cartridge members 210. For example, the drawings illustrate that three cartridge members 210 are disposed in the first direction D1 in the mid-casing member 100 (e.g., FIG. 2).

The first hole H1 may provide a flow path through which a fluid (e.g., a fluid containing water discharged from a fuel cell) is introduced into the humidifier 10. The second hole H2 may provide a flow path through which the fluid is discharged to an outside of the humidifier 10 from the inside of the humidifier 10. According to the present disclosure, a means may be applied to reduce an overall flow velocity of the fluid introduced through the first hole H1.

For example, according to the present disclosure, as illustrated in FIG. 2, the plurality of cartridge members 210 may be positioned/distributed within a width/first distance (reference numeral/distance A in FIG. 2), in a first direction D1, of the first hole H1 of the mid-casing member 100. As illustrated in the FIG. 2, for example, in case that the cartridge part 200 includes three cartridge members 210, two opposite ends (in/relative to the first direction D1) of the three cartridge members 210 may be positioned within the width A, in the first direction D1, of the first hole H1. The fluid, which may be introduced into the mid-casing member 100 via the first hole H1, may be introduced into the internal space of the mid-casing member 100 through/via i) a space and/or channel between the mid-casing member 100 and the cartridge members 210 disposed at the outermost sides and/or ii) a space and/or channel between the two adjacent cartridge members 210, such that a cross-sectional area of a region in which the fluid flows from an inlet region of the humidifier may be increased. According to the present disclosure, during the process in which the fluid is introduced into the humidifier, all/any of the plurality of cartridge members 210 provided in the cartridge part 200 may collide/interact with the fluid. The above-mentioned two elements (e.g., spaces/channels between two adjacent cartridge members 210 and space between the mid-casing member 100 and the outermost cartridge members 210) may decrease a flow velocity of the fluid to be supplied to the humidifier. Therefore, it may be possible to reduce a degree to which water (e.g., which may stagnate in the mid-casing member 100) is scattered by the flow velocity of the fluid introduced into the first hole H1 (e.g., if/when the fluid is supplied to the humidifier according to the present disclosure). As a result, it may be possible to minimize/reduce a degree to which the scattering water comes into direct contact with the humidification membrane member 300.

As illustrated in FIGS. 1 and 4, the humidifier 10 according to the present disclosure may further include a fixing part 400 accommodated in the mid-casing member 100. The fixing part 400 may be configured such that at least one side of the cartridge part 200 is fixed to the fixing part 400. For example, at least one side of the cartridge part 200 may be fixed to the fixing part 400. According to the present disclosure, a part of the cartridge part 200 may protrude from the fixing part 400 toward two opposite sides based on a second direction D2 intersecting the first direction D1. For example, the first direction D1 and the second direction D2 may be horizontal directions, and/or the first direction D1 and the second direction D2 may be orthogonal to each other.

As illustrated in FIG. 1, according to the present disclosure, the cartridge part 200 may have an asymmetric shape. For example, the cartridge part 200 may be asymmetric with respect to the fixing part 400. The cartridge part 200 may protrude from the fixing part 400 by a first length toward a first side in the second direction D2. The cartridge part 200 may protrude from the fixing part 400 by a second length toward a second side in the second direction D2. The first length may be different from the second length.

According to an example of the present disclosure, the first hole H1 and the second hole H2 may be formed in one side surface of a lateral surface (e.g., a first side surface portion) of the mid-casing member, where the side surface is a side primarily in (e.g., facing, substantially facing, substantially normal to) a third direction D3 intersecting the first direction D1 and the second direction D2. For example, the third direction D3 may be an upward/downward direction, and the first hole H1 and the second hole H2 may be formed in an upper surface of the mid-casing member 100.

With reference to FIGS. 1 and 3, for example, a window region 220 having through-holes 227 may be formed on at least a part of each of the plurality of cartridge members 210. The fluid in the mid-casing member 100 may be introduced into the cartridge member 210 through/via the window region 220. For example, the window region 220 (e.g., for a cartridge member 210 of the plurality of cartridge members) may comprise a region of the cartridge member 210 in which the through-holes 227 are formed. The air may be humidified by the fluid (e.g., water) and/or the air, which is to be introduced into the fuel cell from the humidifier 10, exchange water vapor with each other on/via the humidification membrane member 300. For example, the drawings illustrate an example in which the through-holes 227 are disposed in three rows in the window region 220 at each of the two opposite sides of the mid-casing member 100 based on the second direction D2.

The window region 220 may include a first window region 222 provided to be close to a first side, in the second direction D2, of the cartridge member 210. The first window region 222 may have one or more first through-holes 227. The window region 220 may include a second window region 224 provided to be close to a second side, in the second direction D2 opposite the first side, of the cartridge member 210. The second window region 224 may have one or more second through-holes 227. As illustrated in the drawings, the first window region 222 may be provided adjacent to the first hole H1, and the second window region 224 may be provided adjacent to the second hole H2.

With continued reference to FIGS. 1 and 3, the first window region 222 and/or the second window region 224 may have a stepped section 226 formed where one or more portions of the first window region 222 and/or the second window region 224 with a first thickness meets another portion of the first window region 222 and/or the second window region 224 with a second thickness. The stepped section 226 may extend in a direction parallel to the third direction D3. It may be understood that, based on the stepped section 226 as a boundary, a thickness of the window region at one side, in the second direction D2, of the stepped section 226 and a thickness of the window region at the other side, in the second direction D2, of the stepped section 226 may be different from each other. For example, a thickness of a portion of the window region 220 positioned outward (e.g., away from the cartridge members 210 based on the second direction D2) relative to the stepped section 226 as the boundary may be smaller than a thickness of a portion of the window region 220 positioned inward (e.g., towards the cartridge members 210 based on the second direction D2) relative to the stepped section 226 as the boundary.

A portion of the window region positioned relatively outward may be a so-called dead zone region that is a region in which it is relatively difficult to supply a fluid for removing water from the humidification membrane member in case that the water, which stagnates in the mid-casing member, scatters and comes into contact with the humidification membrane member. As described herein, the thickness of the portion of the window region 220 positioned outward being relatively small (e.g., relative to the portion of the window region 220 positioned inward) may allow for the fluid may be more smoothly introduced into the mid-casing member 100 through/via the through-holes 227 formed in the portion of the window region 220 positioned outward based on the second direction D2 (e.g., more smoothly relative to a case in which the thicknesses are not different and/or the portion of the window region 220 positioned outward is not relatively small), such that the water may be smoothly removed from the humidification membrane member. For example, the drawings illustrate that a thickness of the portion, having the through-holes 227 positioned at the outermost side(s) in the second direction D2, among the through-holes 227 disposed in three rows arranged in the second direction D2 and formed in each of the first and second window regions 222 and 224, is relatively small (e.g., where the portion is defined by the stepped section 226 as a boundary).

According to the present disclosure, the first length, which is the length by which the cartridge part 200 protruding from the fixing part 400 toward the first hole H1 in the second direction D2, may be shorter than the second length, that is the length by which the cartridge part 200 protrudes from the fixing part 400 toward the second hole H2 in the second direction D2. This asymmetric arrangement may allow/facilitate the fluid, which is introduced into the mid-casing member 100 through the first hole H1, to be evenly introduced into the through-holes 227 formed in the first window region 222. For example, according to the present disclosure, the fluid introduced through/via the first hole H1 may be smoothly supplied to the through-holes 227 positioned towards the outside of the first window region 222 (e.g., in the second direction D2). Therefore, according to the present disclosure, the dead zone region may be reduced or eliminated.

The humidifier 10 according to the present disclosure may allow the fluid containing the water supplied to the mid-casing member 100 through/via the first hole H1 to move to a region adjacent to the second hole H2 without passing through the cartridge part 200.

For example, as illustrated in FIGS. 1 and 4, a bypass space BP may be formed between the fixing part 400 and an inner surface of the mid-casing member 100. The bypass space BP may allow i) a space, which accommodates the portion of the cartridge part 200 protruding from the fixing part 400 toward one side based on the second direction D2, and ii) a space, which accommodates the portion of the cartridge part 200 protruding from the fixing part 400 toward the other side based on the second direction D2, to communicate with each other (e.g., via fluid and/or air flow).

As described herein, in case that the first hole H1 and the second hole H2 are formed in a side surface of the lateral surface of the mid-casing member 100 (e.g., the lateral surface facing and/or substantially normal to the third direction D3 intersecting the first direction D1 and the second direction D2), the bypass space BP may be provided to face the first hole H1 and the second hole H2 in the third direction D3 with the cartridge part 200 interposed therebetween. The drawings illustrate that the first hole H1 and the second hole H2 are formed in the upper surface of the mid-casing member 100, and the bypass space BP is formed in an inner surface of a lower region of the mid-casing member 100. For example, a part of the bypass space BP may be defined by the inner surface of the mid-casing member based on the first direction D1.

As described herein, in case that the first hole H1 and the second hole H2 are formed in one side surface of the lateral surface of the mid-casing member 100 based on the direction (e.g., the third direction D3) intersecting the second direction D2, the first window region 222 may be provided at a position spaced apart outward from the first hole H1 in the second direction D2, and/or the second window region 224 may be provided at a position spaced apart outward from the second hole H2 in the second direction D2. For example, the second window region 224 may be provided at the position spaced apart outward from the second hole H2 in the second direction D2. As illustrated in FIG. 1 and the like, at least a part of the first window region 222 may overlap the first hole H1 in the second direction D2, whereas the entire portion of the second window region 224 may be spaced apart from the second hole H2 in the second direction D2. This may prevent/reduce the scattering drain water from being introduced into the humidification membrane member through the through-holes 227 formed in the second window region 224.

As described herein, the first hole H1 and the second hole H2 may be formed in one side surface of the lateral surface of the mid-casing member 100, where the lateral surface faces (e.g., substantially faces, is substantially normal to) the third direction D3. The first hole H1 may be formed in one side surface (e.g., first side surface portion) of the lateral surface of the mid-casing member 100 based on the third direction D3, whereas the second hole H2 may be formed in a portion (e.g., a second side surface portion) of the lateral surface of the mid-casing member 100 opposite to the one side surface in the third direction D3. Also, or alternatively, the first hole H1 may be formed in one side surface (e.g., a first side surface portion) of the lateral surface of the mid-casing member 100 based on the third direction D3, whereas the second hole H2 may be positioned/formed in a second side surface portion of the lateral surface based on the first direction D1 (e.g., where the second side surface portion faces, substantially faces, is substantially normal to, etc., the first direction D1).

The window region 220 according to the present disclosure may be formed on a lateral surface of the cartridge member 210 (e.g., a lateral surface of the cartridge member 210 based on/in the first direction D1). Discharge holes 228 may be formed in lateral surfaces of the cartridge members 210 based on/in a direction intersecting the first direction D1. For example, the discharge hole 228 may be formed in a side surface of the cartridge member 210 based on the third direction D3. In case that the third direction D3 is the upward/downward direction, the discharge hole 228 may be formed in a lower surface of the cartridge member 210.

The discharge hole 228 may be configured to discharge water (e.g., introduced into the cartridge member 210 via the first hole H1 and/or the window region 220) to the outside. The discharge hole 228 may be formed at a position that faces the window region 220 in the third direction D3. For example, the discharge holes 228 may be formed at positions that respectively face the first window region 222 and the second window region 224 (e.g., in the third direction D3). The discharge hole 228 may include a first discharge hole formed to overlap the first window region 222 (e.g., in the second direction D2), and a second discharge hole formed to overlap the second window region 224. In case that the discharge hole 228 is provided to overlap the window region 220 in the second direction D2 (e.g., to face the window region 220 in the third direction D3), the water (e.g., introduced into the cartridge member 210 through/via the window region 220) may be smoothly discharged to the outside through the discharge hole 228 by gravity, for example. For example, the discharge hole 228 may be formed to be relatively adjacent to an outer end of the two opposite ends (in the second direction D2) of the window region 220 in consideration of the fact that the water attached to the humidification membrane member in the outer (e.g., in the second direction D2) region of the window region 220 may not be properly removed.

With reference to FIGS. 1 and 6, the humidifier 10 according to the present disclosure may further include a drain pipe part 500 (e.g., a drain pipe) connected to a side surface of the lateral surface of the mid-casing member 100 (e.g., a lateral surface substantially normal to the third direction D3 intersecting the first direction D1 and the second direction D2). The drain pipe part 500 may be configured to define a flow path/channel into which water (e.g., intermittently discharged from a fuel cell stack in/of the fuel cell system) is introduced. The water to be introduced into the humidifier 10, according to the present disclosure, may include i) water discharged from the fuel cell stack and introduced through/via the above-mentioned first hole H1 and/or ii) water introduced through/via the drain pipe part 500.

According to the present disclosure, a portion of the drain pipe part 500 connected to the mid-casing member 100 may be provided to be spaced apart, in the second direction D2, from the first window region 222 and the second window region 224. The portion of the drain pipe part 500 provided to be spaced apart from the first window region 222 and/or the second window region 224 may prevent/reduce the water introduced into the humidifier 10 through/via the drain pipe part 500 from being introduced immediately/directly into the humidification membrane member 300 (e.g., through/via the first window region 222 or the second window region 224). For example, as illustrated in FIGS. 1 and 6, the portion of the drain pipe part 500 connected to the mid-casing member 100 may be positioned between the first window region 222 and the second window region 224 in the second direction D2.

The present disclosure has been made in an effort to minimize a degradation of a humidification membrane in a humidifier by improving a structure of a humidifier.

In order to achieve the above-mentioned object, one aspect of the present disclosure provides a humidifier including: a mid-casing member having therein a space and having a first hole formed at one side thereof, and a second hole formed at the other side thereof; a cartridge part including a plurality of cartridge members accommodated in the mid-casing member and disposed to be spaced apart from one another in a first direction D1; and humidification membrane members accommodated in the cartridge members, in which two opposite ends of the plurality of cartridge members based on the first direction D1 are positioned within a width of the first hole in the first direction D1.

The humidifier may further include: a fixing part accommodated in the mid-casing member and configured such that at least one side of the cartridge part is fixed to the fixing part, in which a part of the cartridge part protrudes from the fixing part toward two opposite sides based on a second direction D2 intersecting the first direction D1, and in which a first length, which is a length by which the cartridge part protrudes from the fixing part toward one side based on the second direction D2, is different from a second length that is a length by which the cartridge part protrudes from the fixing part toward the other side based on the second direction D2.

The first hole and the second hole may be formed in one side surface of a lateral surface of the mid-casing member based on a third direction D3 intersecting the first direction D1 and the second direction D2, a window region having through-holes may be formed on at least a part of each of the plurality of cartridge members, the window region may include: a first window region provided to be close to one side of the cartridge member based on the second direction D2 and having one or more first through-holes; and a second window region provided to be close to the other side of the cartridge member based on the second direction D2 and having one or more second through-holes, and the first window region or the second window region may have a stepped section formed as portions with different thicknesses meet together.

A thickness of a portion of the window region positioned outward based on the second direction D2 based on the stepped section as a boundary may be smaller than a thickness of a portion of the window region positioned inward based on the second direction D2 based on the stepped section as the boundary.

The humidifier may further include: a fixing part accommodated in the mid-casing member and configured such that at least one side of the cartridge part is fixed to the fixing part, in which a part of the cartridge part protrudes from the fixing part toward two opposite sides based on a second direction D2 intersecting the first direction D1, and in which a bypass space is formed between the fixing part and an inner surface of the mid-casing member and allows i) a space, which accommodates the portion of the cartridge part protruding from the fixing part toward one side based on the second direction D2, and ii) a space, which accommodates the portion of the cartridge part protruding from the fixing part toward the other side based on the second direction D2 to communicate with each other.

The first hole and the second hole may be formed in one side surface of a lateral surface of the mid-casing member based on a third direction D3 intersecting the first direction D1 and the second direction D2, and the bypass space may be provided to face the first hole in the third direction D3 with the cartridge part interposed therebetween.

A part of the bypass space may be defined by an inner surface of the mid-casing member based on the first direction D1.

The humidifier may further include: a fixing part accommodated in the mid-casing member and configured such that at least one side of the cartridge part is fixed to the fixing part, in which a part of the cartridge part protrudes from the fixing part toward two opposite sides based on a second direction D2 intersecting the first direction D1, in which the first hole and the second hole are formed in one side surface of a lateral surface of the mid-casing member based on a direction intersecting the second direction D2, in which a window region having through-holes is formed on at least a part of each of the plurality of cartridge members, in which the window region includes: a first window region provided to be close to one side of the cartridge member based on a direction toward the first hole in the second direction D2 and having one or more first through-holes; and a second window region provided to be close to one side of the cartridge member based on a direction toward the second hole in the second direction D2 and having one or more second through-holes, and in which i) the first window region is provided at a position spaced apart outward from the first hole in the second direction D2 or ii) the second window region is provided at a position spaced apart outward from the second hole in the second direction D2.

The first hole may be formed in one side surface of the lateral surface of the mid-casing member based on a third direction D3 intersecting the first direction D1 and the second direction D2, and the second hole may be formed in the other side surface of the lateral surface of the mid-casing member opposite to one side surface in the third direction D3.

The first hole may be formed in one side surface of the lateral surface of the mid-casing member based on a third direction D3 intersecting the first direction D1 and the second direction D2, and the second hole may be formed in one side surface of the lateral surface of the mid-casing member based on the first direction D1.

The humidifier may further include: a fixing part accommodated in the mid-casing member and configured such that at least one side of the cartridge part is fixed to the fixing part, in which a part of the cartridge part protrudes from the fixing part toward two opposite sides based on a second direction D2 intersecting the first direction D1, in which a window region having through-holes is formed on at least a part of each of the plurality of cartridge members, in which the window region is formed on one side surface of each of the plurality of cartridge members based on the first direction D1, and in which a discharge hole is formed in one side surface of each of the plurality of cartridge members based on a direction intersecting the first direction D1.

The discharge hole may be formed in one side surface of each of the plurality of cartridge members based on a third direction D3 intersecting the first direction D1 and the second direction D2.

The window region may include: a first window region provided to be close to one side of the cartridge member based on the second direction D2 and having one or more first through-holes; and a second window region provided to be close to the other side of the cartridge member based on the second direction D2 and having one or more second through-holes, and the discharge holes may include: a first discharge hole formed to overlap the first window region in the second direction D2; and a second discharge hole formed to overlap the second window region in the second direction D2.

The discharge hole may be formed to be relatively adjacent to an outer end of two opposite ends of the window region based on the second direction D2.

The humidifier may further include: a drain pipe part connected to one side surface of a lateral surface of the mid-casing member based on a third direction D3 intersecting the first direction D1 and a second direction D2, in which a window region having through-holes is formed on at least a part of each of the plurality of cartridge members, in which the window region includes: a first window region provided to be close to one side of the cartridge member based on the second direction D2 and having one or more first through-holes; and a second window region provided to be close to the other side of the cartridge member based on the second direction D2 and having one or more second through-holes, and in which a portion of the drain pipe part connected to the mid-casing member is provided to be spaced apart from the first window region and the second window region in the second direction D2.

The portion of the drain pipe part connected to the mid-casing member may be positioned between the first window region and the second window region in the second direction D2.

According to the present disclosure, it is possible to minimize the degradation of the humidification membrane in the humidifier by improving the structure of the humidifier.

The present disclosure has been described with reference to the limited examples and the drawings, but the present disclosure is not limited thereby. The present disclosure may be carried out in various forms by those skilled in the art, to which the present disclosure pertains, within the technical spirit of the present disclosure and the scope equivalent to the appended claims.

What is claimed is:

1. A humidifier comprising:
a casing having a surface in which a first hole and a second hole are formed;
a cartridge part comprising a plurality of cartridges accommodated in a space formed by the casing, wherein the plurality of cartridges are disposed to be spaced apart from each other in a first direction; and
a plurality of humidification membranes accommodated in the plurality of cartridges,
wherein the plurality of cartridges are positioned within a width of the first hole in the first direction, such that channels are formed between outer cartridge members, of the plurality of cartridges in the first direction, and an internal surface of the casing.

2. The humidifier of claim 1, further comprising:
a fixing part accommodated in the casing and configured such that at least one side of the cartridge part is fixed to the fixing part,
wherein a first part of the cartridge part extends from a first end of the fixing part and a second part of the cartridge part extends from a second end of the fixing part, wherein the first end and the second end are opposite to each other in a second direction intersecting the first direction, and
wherein a first length of the first part in the second direction is different from a second length of the second part in the second direction.

3. The humidifier of claim 1, wherein the surface in which the first hole and the second hole are formed faces a third direction intersecting the first direction and a second direction intersecting the first direction,
wherein each cartridge of the plurality of cartridges comprises a window region in which through-holes are formed,
wherein each window region comprises:
a first window region, provided towards a first end of the cartridge in the second direction, in which one or more first through-holes are formed; and
a second window region, provided towards a second end of the cartridge opposite the first end in the second direction, in which one or more second through-holes are formed,
wherein at least one of the first window region or the second window region comprise portions with different thicknesses, wherein a step is formed between the portions.

4. The humidifier of claim 3, wherein the portions comprise:
a first portion positioned outward in the second direction relative to the step; and
a second portion positioned inward in the second direction relative to the step, wherein a thickness of the first portion is smaller than a thickness of the second portion.

5. The humidifier of claim 1, further comprising:
a fixing part accommodated in the casing and configured such that at least one side of the cartridge part is fixed to the fixing part,
wherein a first part of the cartridge part extends from a first end of the fixing part and a second part of the cartridge part extends from a second end of the fixing part, wherein the first end and the second end are opposite to each other in a second direction intersecting the first direction, and
wherein a bypass space is formed between the fixing part and an inner surface of the casing, wherein the bypass space is configured to allow communication between i) a space that accommodates the first part of the cartridge part and ii) a space that accommodates the second part of the cartridge part.

6. The humidifier of claim 5, wherein the surface in which the first hole and the second hole are formed faces a third direction intersecting the first direction and the second direction, and
wherein cartridge part is disposed between the bypass space and first hole in the third direction.

7. The humidifier of claim 5, wherein a part of the bypass space is defined by an inner surface of the casing in the first direction.

8. The humidifier of claim 1, further comprising:
a fixing part accommodated in the casing and configured such that at least one side of the cartridge part is fixed to the fixing part,
wherein a first part of the cartridge part extends from a first end of the fixing part and a second part of the cartridge part extends from a second end of the fixing part, wherein the first end and the second end are opposite to each other in a second direction intersecting the first direction,
wherein the surface in which the first hole and the second hole are formed faces a direction intersecting the second direction,
wherein each cartridge of the plurality of cartridges comprises a window region in which through-holes are formed,
wherein each window region comprises:
a first window region, provided towards a first end of the cartridge in the second direction, in which one or more first through-holes are formed; and
a second window region, provided towards a second end of the cartridge in the second direction in which one or more second through-holes are formed, and
wherein i) the first window region is provided at a position spaced apart outward from the first hole in the second direction or ii) the second window region is provided at a position spaced apart outward from the second hole in the second direction.

9. The humidifier of claim 8, wherein the first hole is formed in a first side surface portion of the surface of the casing, wherein the first side surface portion faces a third direction intersecting the first direction and the second direction, and
wherein the second hole is formed in a second side surface portion of the surface of the casing, wherein the second side surface portion is opposite to the first side surface portion in the third direction.

10. The humidifier of claim 8, wherein the first hole is formed in a first side surface portion of the surface of the casing, wherein the first side surface portion faces a third direction intersecting the first direction and the second direction, and
wherein the second hole is formed in a second side surface portion of the surface of the casing, wherein the second side surface portion faces the first direction.

11. The humidifier of claim 1, further comprising:
a fixing part accommodated in the casing and configured such that at least one side of the cartridge part is fixed to the fixing part,
wherein a first part of the cartridge part extends from a first end of the fixing part and a second part of the cartridge part extends from a second end of the fixing part, wherein the first end and the second end are opposite to each other in a second direction intersecting the first direction,
wherein each cartridge of the plurality of cartridges comprises a window region in which through-holes are formed, and wherein, for each cartridge:
the window region is formed on a side surface, of the cartridge, facing the first direction, and
a discharge hole is formed in a side surface, of the cartridge, facing a direction intersecting the first direction.

12. The humidifier of claim 11, wherein the side surface in which the discharge hole is formed faces a third direction intersecting the first direction and the second direction.

13. The humidifier of claim 11, wherein the window region comprises:
a first window region, provided towards a first end of the cartridge in the second direction, in which one or more first through-holes are formed; and
a second window region, provided towards a second end of the cartridge in the second direction, in which one or more second through-holes are formed, and
wherein the discharge holes comprise:
a first discharge hole formed to overlap the first window region in the second direction; and
a second discharge hole formed to overlap the second window region in the second direction.

14. The humidifier of claim 11, wherein the discharge hole is formed to be relatively adjacent to an outer end the window region in the second direction.

15. The humidifier of claim 1, further comprising:
a drain pipe connected to a side surface of the casing wherein the side surface faces a third direction intersecting the first direction and a second direction,
wherein each cartridge of the plurality of cartridges comprise a window region in which through-holes are formed,
wherein each window region comprises:
a first window region provided towards a first end of the cartridge in the second direction, in which one or more first through-holes are formed; and
a second window region provided towards a second end of the cartridge in the second direction, in which one or more second through-holes are formed, and
wherein a portion of the drain pipe connected to the casing is provided to be spaced apart, in the second direction, from the first window region and the second window region.

16. The humidifier of claim 15, wherein the portion of the drain pipe connected to the casing is positioned between the first window region and the second window region in the second direction.

17. A humidifier comprising:
a casing having a surface in which a first hole and a second hole are formed;
a plurality of cartridges accommodated in a space formed by the casing, wherein the plurality of cartridges are disposed to be spaced apart from each other in a first direction; and
a plurality of humidification membranes accommodated in the plurality of cartridges,
wherein each cartridge of the plurality of cartridges comprises a window region in which through-holes are formed,
wherein each window region comprises:
a first window region, provided towards a first end of the cartridge in a second direction intersecting the first direction, in which one or more first through-holes are formed; and
a second window region, provided towards a second end of the cartridge opposite the first end in the second direction, in which one or more second through-holes are formed,
wherein at least one of the first window region or the second window region comprise portions with different thicknesses.

18. The humidifier of claim 17, wherein the plurality of cartridges are positioned within a width of the first hole in the first direction, such that channels are formed between outer cartridge members, of the plurality of cartridges in the first direction, and an internal surface of the casing.

19. The humidifier of claim 17, wherein the portions comprise:
a first portion positioned outward in the second direction; and
a second portion positioned inward in the second direction, wherein a thickness of the first portion is smaller than a thickness of the second portion.

20. A humidifier comprising:
a casing having a surface in which a first hole and a second hole are formed;
a plurality of cartridges in a space formed by the casing, wherein the plurality of cartridges are disposed to be spaced apart from each other in a first direction and spaced apart from internal surfaces of the casing facing the first direction, such that a plurality of channels are formed, from the first hole, between the plurality of cartridges and the internal surfaces of the casing; and
a plurality of humidification membranes accommodated in the plurality of cartridges.
